(19) United States
(12) Patent Application Publication
(10) Pub. No.: US 2025/0050795 A1
(43) Pub. Date: Feb. 13, 2025

(54) VEHICLE FLOOR MAT ASSEMBLY

(71) Applicant: Honda Motor Co., Ltd., Tokyo (JP)

(72) Inventors: Zainab I. ALI, Marysville, OH (US); Gwendolyn S. ALTENHOF, Columbus, OH (US)

(21) Appl. No.: 18/231,901

(22) Filed: Aug. 9, 2023

(51) Int. Cl. B60N 3/04

(52) U.S. Cl. CPC B60N 3/048; B60N 3/044

(57) ABSTRACT

A vehicle floor mat assembly includes a first mat member formed of a first material and a second mat member formed of a second material that is different than the first material. The first and second mats can be removably connected to one another and/or are inhibited from moving relative to one another. Each of the first mat member and the second mat member can be independently usable relative to the other of the first and second mat members.

### BACKGROUND

Floor mats in vehicles have many design considerations. Functional design considerations include providing a robust, versatile and long-lasting mat. Aesthetic design considerations includes providing a floor mat that has a good appearance. There are often competing design and aesthetic considerations for floor mats, including having a more textile-based floor mat during more pleasant seasons and a more rubber-like floor mat for more inclement seasons. Many vehicle owners maintain two sets of floor mats, including a textile-type set of mats and a rubber-type set of mats. These are exchanged with the interchanging seasons. Additionally, various features are often embedded in floor mats, including metal gromets that are of a different material than the floor mat. This can sometimes hinder recycling efforts due to the inclusion of two different materials in a common floor mat.

### BRIEF DESCRIPTION

According to one aspect, a vehicle floor mat assembly includes a first mat member formed of a first material and a second mat member formed of a second material that is different than the first material. The first and second mats can be removably connected to one another and/or are inhibited from moving relative to one another. Each of the first mat member and the second mat member can be independently usable relative to the other of the first and second mat members.

According to another aspect, a floor mat assembly for a vehicle includes a textile floor mat member formed of a first material and a non-textile floor mat member formed of a second material that is different from the first material. Each of the textile floor mat member and the non-textile floor mat member are independently useable without the other of the textile floor mat member and the non-textile floor mat member. The textile floor mat member and the non-textile floor mat member can be useable together in a stacked configuration.

According to a further aspect, a two-piece mat assembly includes a first textile mat member formed of a first textile material and a second non-textile mat member formed of a second resilient non-textile member. The first and second mat members are removably connected to one another and/or are inhibited from moving relative to one another. Each of the first textile mat member and the second non-textile mat member is independently useable without the other of the first textile mat member and the second non-textile mat member. The first textile mat member and the second non-textile mat member are also useable together in a stacked configuration.

### BRIEF DESCRIPTION OF THE DRAWINGS

FIG. 1 is a partial perspective view of a vehicle floor mat assembly arranged in a driver side area of a vehicle with the floor mat assembly including a first mat member and a second mat member according to an exemplary embodiment.

FIG. 2 is a cross-section view of the vehicle floor mat assembly of FIG. 1 taken along the line 2-2 of FIG. 1.

FIG. 3 is a cross-section view similar to FIG. 2 but showing an alternate embodiment wherein a protruding feature has an inverted T-shape.

FIG. 4 is a perspective view of a vehicle floor mat assembly according to another alternate exemplary embodiment.

FIG. 5 is a partial perspective view, partially in cross-section, of a vehicle floor mat assembly according to a further alternate embodiment.

FIG. 6 is a partial perspective view, partially in cross-section, of a vehicle floor mat assembly according to still a further alternate exemplary embodiment.

### DETAILED DESCRIPTION

It should, of course, be understood that the description and drawings herein are merely illustrative and that various modifications and changes can be made in the structures disclosed without departing from the present disclosure. Spatially relative terms may be used to describe an element and/or feature's relationship to another element(s) and/or feature(s) as, for example, illustrated in the figures. Moreover, any term of degree used herein, such as “substantially”, means a reasonable amount of deviation of the modified word is contemplated such that the end result is not significantly changed.

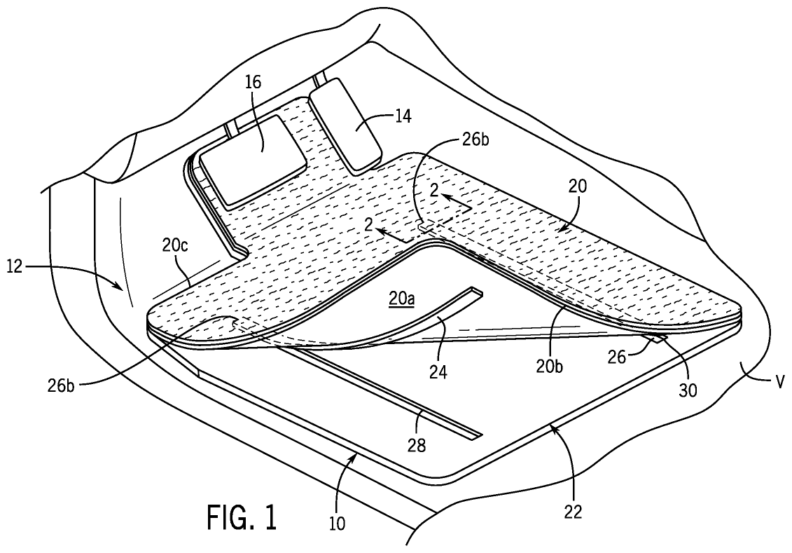

Referring now to the drawings, wherein like numerals refer to like parts throughout the several views, FIG. 1 illustrates a vehicle V having a vehicle floor mat assembly 10 according to an exemplary embodiment. As shown, the vehicle floor mat assembly 10 is shown in a driver's side floor area 12 of the vehicle V. in particular, the vehicle floor mat assembly 10 is provided below an accelerator pedal 14 and a brake pedal 16. However, it is to be appreciated that the vehicle floor mat assembly 10 could be provided in other areas of the vehicle, for example, a front passenger side floor area, rear passenger floor areas, etc. (other areas not shown). In this regard, the vehicle floor mat assembly 10 can have other shapes, particularly perimeter shapes, than illustrated in FIG. 1.

The vehicle floor mat assembly 10 includes a first mat member 20, also referred to herein as a textile floor mat member, and a second mat member 22, also referred to herein as a non-textile floor mat member. According to an exemplary embodiment, the first mat member 20 can be formed of a first material and the second mat member 22 can be formed of a second material that is different than the first material. Additionally, the first and second mat members are removably connected to one another and/or are inhibited from moving relative to one another as will be described in more detail below.

Additionally, and also according to an exemplary embodiment, each of the first mat member 20 and the second mat member 22 can be independently useable relative to the other of the first and second mat members 20, 22. In this regard, there are no elements of either of the first and second mat members 20, 22 that protrude in an inconvenient or ineffective manner so as to prevent one of the first and second mat members 20, 22 from being used independently relative to the other in the first and second mat members 20, 22. When used together, the first and second mat members 20, 22 are useable together in a stacked configuration, such as shown at least in part, in FIG. 1. For example, as shown, the first mat member 20 can be stacked on top of the second mat member 22. In the stacked configuration, the first floor mat 20 and the second floor mat member 22 are removably couple to one another and/or are inhibited from moving relative to one another.

At least one of the first mat member 20 and the second mat member 22 can include a protruding feature (for example, protruding strips 24, 26) that is complementarily received in a corresponding grooved feature (for example, groove features or grooves 28, 30) disposed on the other of the first mat member 20 and the second mat member 22. In the illustrated embodiment, the first mat member 20 has the protruding feature, and particularly protruding features 24, 26, extending from an underside 20a thereof and the second floor mat member 22 has the grooved feature, particularly grooved features 28, 30, disposed in an upwardly fixing surface 22a of the second mat member 22. In an alternate embodiment, the protruding feature could be disposed on the upper surface 22a of the second mat member 22 and the grooved feature could be disposed on the underside 20a of the first floor mat member 20. The removable receipt of the protruding feature (i.e., the protruding strips 24, 26) in the corresponding groove feature (i.e., the grooves 28, 30) can include a friction fit or snap fit coupling to inhibit removal of the protruding feature from the corresponding groove feature.

More particularly, in the illustrated embodiment, the protruding features 24, 26 are in the form of protruding strips or strip members disposed on the underside 20a of the first mat member 20. In particular, the strips 24, 26 are spaced apart from one another in a lateral direction relative to the vehicle V and extend along a substantial portion of a longitudinal extent of the first mat member 20. The grooved features 28, 30 can be in the form of complementary grooves defined in the upwardly facing surface 22a of the second mat member 22. As shown, forward ends 24a, 26a of their respective protruding strips 24, 26 can be spaced apart from a forward edge 20b of the first mat member 20. Likewise, rearward ends 24b, 26b can be spaced apart from a rearward edge 20c of the first mat member 20.

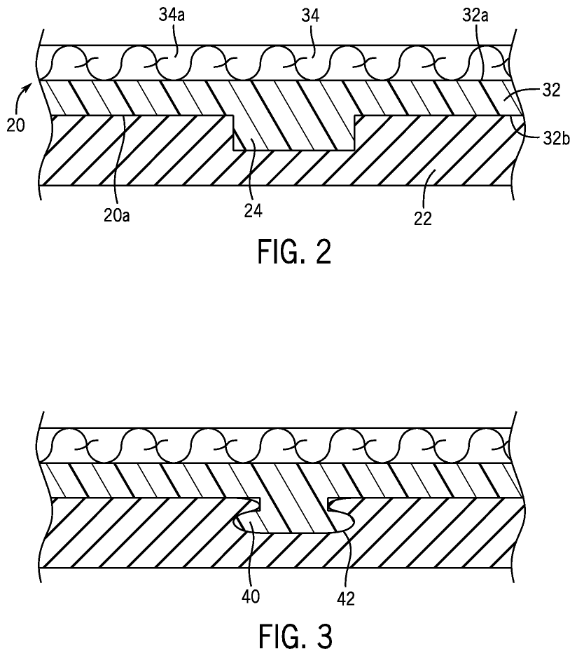

With additional reference to FIG. 2, the protruding strip is shown complementarily received in the corresponding groove 30 of the second mat member 22. The fit between the protruding strips 24, 26 and the grooves 28, 30 can be a friction t such that the first and second mat members 20, 22 are removably secured together and inhibited from decoupling from one another. That is, a sufficient pulling force is required to be applied to the mat members 20, 22 in order to decouple the first and second mat members 20, 22 from one another. Notably, the strips 24, 26 protrude form the underside 20a a minimal amount so as to not interfere with the first floor mat 20 being used independent of the second floor mat 22 but a sufficient amount so as to be removably coupled with the second floor mat 22 in the grooved features 28, 30 thereof.

In a particular embodiment, the first mat member 20 can be formed solely from a first material and a second mat member 22 can likewise be formed solely from the second material that is different than the first material of the first mat member 20. In particular, in one embodiment, the first mat member 20 can be a textile floor mat and the second mat member 22 can be a resilient or rubber floor mat. For example, the first material of the first mat member 20 can be a PET or nylon, for example. In one embodiment, the first mat member 20 is unitarily formed from polyester, (e.g., polyethylene terephthalate or PET) or nylon. The second mat member can be formed from the second material that is a thermoplastic elastomer (TPE), such as thermoplastic vulcanizate (TPV). In one embodiment, the second mat member 22 is unitarily formed from TPE or TPV. As used herein, unitarily formed means no other materials are used for the respective first and second mat members 20, 22. This advantageously facilitates easy recycling of the mat members 20, 22. In particular, no separation of particular components of each of the mat members 20, 22 is required before recycling each the mat members 20, 22.

With particular reference to FIG. 2, the first mat member 20 can specifically include a scrim member 32 having a first side 32a and a second side 32b. The first mat member 20 can additionally include a textile layer 32 disposed on the first side 32a of the scrim member 32 and the protruding feature 24 can extend from the second side 32b of the scrim member 32. Each of the scrim member 32 and the textile layer 34 can be formed from the first material, thus the first mat member 20 is entirely formed from the first material. As will be understood and appreciated by those skilled in the art, the textile layer can include woven members 34a interwoven with the scrim member 32.

With additional reference to FIG. 3, an alternate embodiment is shown wherein the protruding feature is an inverted T-shape 40 and the groove feature 42 has a complementary inverted T-shape. As with the embodiment of FIGS. 1 and 2, the inverted T-shape protruding feature 40 can be removably received in the corresponding T-shaped groove 42 in a friction fit or snap fit coupling to inhibit removal of the protruding feature 40 from the groove feature 42 and thereby inhibit decoupling of the first mat member 20 from the second mate member 22. In all other respects, the embodiment of FIG. 3 can be the same or similar to the embodiment of FIGS. 1 and 2.

Optionally, in addition or in lieu of the protruding strips 24, 26 and corresponding grooves 28, 30, the first and second mat members 20, 22 can include a surface feature to inhibit relative movement between the mat members 20, 22. More particularly, at least one of the first mat member 20 or the second mat member 22 can include a surface feature on an engaging surface, for example the upward facing surface 22a of the second mat member 22, that engages the other of the first and second mat members 20, 22. The surface feature can be one of an embossment, a hook and loop fastener or a surface texture feature. This can be for simply inhibiting relative movement between the first and second mat members 20, 22 and need not removably couple the first and second mat members 20, 22 together.

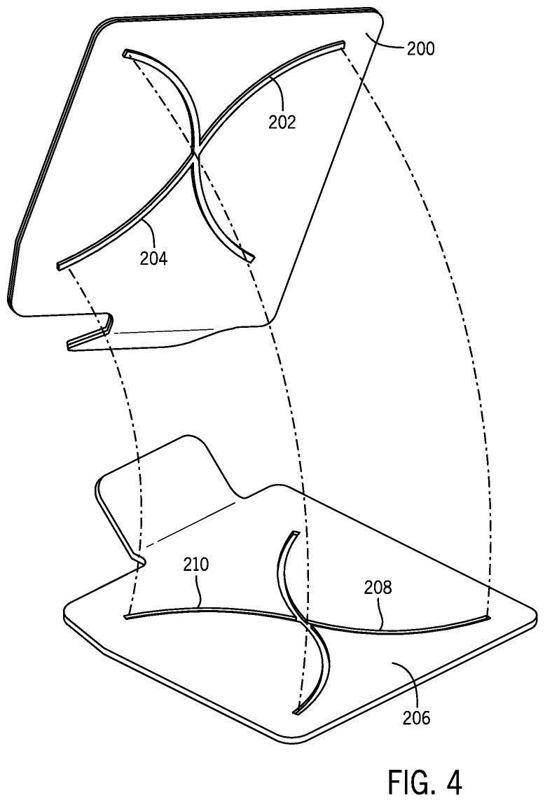

Alternative shapes for the protruding feature or features 24, 26 and corresponding groove or grooves 28, 30 can be provided in still further alternate embodiments. For example, with reference to FIG. 4, a first mat member 200 can include protruding strips 202, 204 in an X-configuration and a second mat member 206 can include corresponding grooves 208, 210. In all other aspects, the first mat member 200 can be the same or similar to the first mat member 20 of FIGS. 1 and 2 and likewise the second mat member 206 can be the same or similar to the second mat member 22 of FIGS. 1 and 2.

The embodiment of FIG. 4 can be varied from what is illustrated. In particular, various designs or patterns for the protruding features 202, 204 can be provided and likewise corresponding designs and patterns for the corresponding grooves 208, 210 can be provided. Also, less than or more than two protruding features can be provided on the first mat member 200 and likewise less or more than two grooves 208, 210 can be provided on the second mat member 206. Optionally, the provision of the protruding feature or features on the first mat member 206 and likewise the groove or grooves on the second mat member 206 can be provided in the form of some trademark or other identifying design.

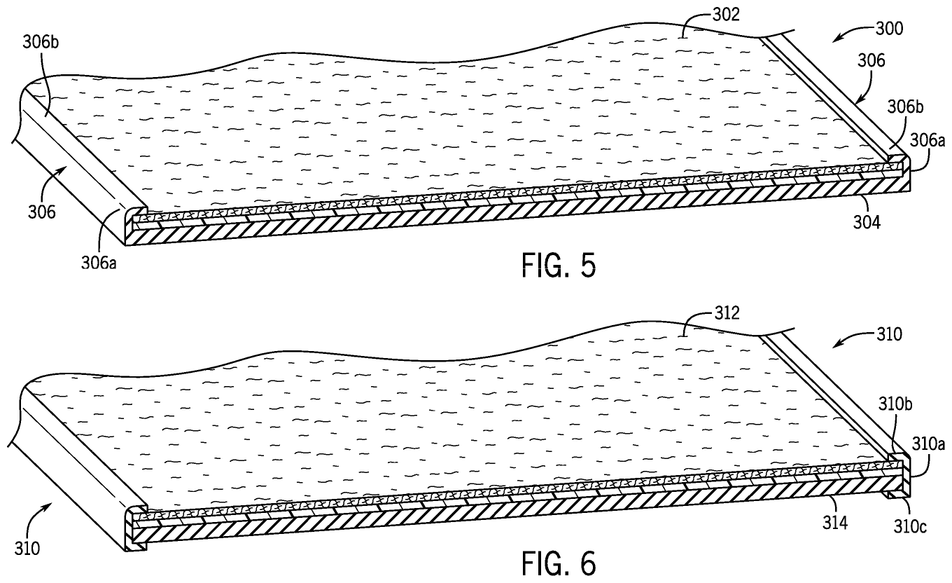

With reference to FIG. 5, another alternate embodiment is shown. In particular, in FIG. 5, a vehicle floor mat assembly 300 is shown including a first mat member 302 formed of a first material and a second mat member 304 formed of a second material that is different than the first material. Except as discussed hereinbelow, the first mat member 302 can be the same or similar to the first mat member 20 of FIGS. 1 and 2 and the second mat member 304 can be the same or similar to the second mat number 22 of FIGS. 1 and 2. Like the mat members 20, 22, the mat members 302, 304 can be removably connected to one another and/or are inhibited from moving relative to one another. In addition, each of the first mat member 302 and the second mat member 304 can be independently used relative to the other of the first and second mat member 302, 304.

Unlike the mat members 20, 22 of FIGS. 1 and 2, the second mat member 304 includes at least one side edge retaining feature 306 that inhibits removal or movement of the first mat member 302 relative to the second mat member 304. In particular, the side edge retaining feature 306 is provided along both lateral sides 304a, 304b of the second mat member 304. In particular, the second mat member 304 of the embodiment illustrated in FIG. 5 includes the pair of side edge retaining features 306, 306 that inhibit removal or movement of the first mat member 302 relative to the second mat member 304.

Each of the pair of side edge retaining features 306 can each include a raised sidewall 306a that extends upward from an upward facing surface 304c of the second mat member 304 and an overhang wall 306b that extends laterally inward from the respective raised sidewall 306a to form a groove in which the first mat member 302 is receivable. To use independent of one another, the first mat member 304 can be slidably removed from the second mat member 304 and then either one of the first mat member 302 or the second mat member 304 can be used independent of the other of the first mat member 302 or the second mat member 304.

With reference now to FIG. 6, another alternate embodiment is shown. In FIG. 6, a pair of side edge retaining member 310, 310 is used to removably connect the first and second mat members 312 and 314 to one another and to allow independent use of the first and second mat members 312, 314 relative to one another. In most respects, the embodiment of FIG. 6 is the same or similar to the embodiment of FIG. 5 except that the second mat member 314 does not include the side edge retaining feature and instead this is provided via a separate member, the side edge retaining member 310. In particular, the first mat member 312 can be the same or similar to the mat member 302 and the second mat member 314 can be the same or similar to the second mat member 306 without the side retaining features 306.

In addition and in lieu of the side retaining features 306, the pair of side edge retaining members 310 can be provided along both lateral sides of the first and second mat members 312, 314. In particular, the side edge retaining members 310, 310 are used when the first and second mat members 312, 314 are used in a stacked configuration together. When one of the mat members 312 or 314 is used independent of the other of the mat members 312, 314, the side edge retaining members 310, 310 can be stored along with the mat member 312 or 314 that is not being used. As shown, the side edge retaining members 310, 310 can each include or have a C-shape with a side wall 310a and a pair of overhang walls 310b, 310c extending from the sidewall 310a to defining groove in which the first mat member 312 is receivable, particularly slidably receivable.

It will be appreciated that various of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A vehicle floor mat assembly, comprising:
a first mat member formed of a first material; and
a second mat member formed of a second material that is different than the first material, wherein the first and second mat members are removably connected to one another and/or are inhibited from moving relative to one another, and further wherein each of the first mat member and the second mat member is independently usable relative to the other of the first and second mat members.

2. The vehicle floor mat assembly of claim 1 wherein at least one of the first mat member and the second mat member includes a protruding feature that is complementarily received in a corresponding grooved feature disposed on the other of the first mat member and the second mat member.

3. The vehicle floor mat assembly of claim 2 wherein the first mat member has the protruding feature extending from an underside thereof and the second mat member has the grooved feature disposed in an upwardly facing surface.

4. The vehicle floor mat assembly of claim 3 wherein the protruding feature is an inverted T-shape and the grooved feature has a complementary inverted T-shape.

5. The vehicle floor mat assembly of claim 2 wherein the first mat member includes a scrim member having a first side and a second side, a textile layer disposed on the first side of the scrim member and the protruding feature extending from the second side of the scrim member.

6. The vehicle floor mat assembly of claim 1 wherein the first mat member is unitarily formed from PET or nylon.

7. The vehicle floor mat assembly of claim 1 wherein the second mat member is unitarily formed from TPE or TPV.

8. The vehicle floor mat assembly of claim 1 wherein the first mat member is a textile floor mat and the second mat member is a resilient or rubber floor mat.

9. The vehicle floor mat assembly of claim 1 wherein at least one of the first mat member and the second mat member includes a surface feature on an engaging surface that engages the other of the first and second mat members.

10. The vehicle floor mat assembly of claim 9 wherein the surface feature is one of an embossment, a hook and loop fastener or a surface texture feature.

11. The vehicle floor mat assembly of claim 1 wherein the first mat member is formed solely from first material and the second mat member is formed solely from the second material.

12. The vehicle floor mat assembly of claim 1 wherein the second mat member includes at least one side edge retaining feature that inhibits removal or movement of the first mat member relative to the second mat member.

13. The vehicle floor mat assembly of claim 12 wherein the second mat member includes a pair of side edge retaining features that inhibit removal or movement of the first mat member relative to the second mat member, the pair of side edge retaining features each including a raised side wall that extends upward from an upward facing surface of the second mat member and an overhang wall that extends laterally inward from the raised side wall to form a groove in which the first mat member is receivable.

14. The vehicle floor mat assembly of claim 1 further including a side edge retaining member that inhibits removal or movement of the first mat member relative to the second mat member.

15. The vehicle floor mat assembly of claim 14 having a C-shape with a side wall and a pair of overhang walls extending from the side wall to define a groove in which the first mat member is receivable.

16. A floor mat assembly for a vehicle, comprising:
a textile floor mat member formed of a first material; and
a non-textile floor mat member formed a second material that is different from the first material,
wherein each of the textile floor mat member and the non-textile floor mat member are independently usable without the other of the textile floor mat member and the non-textile floor mat member, and wherein the textile floor mat member and the non-textile floor mat member are usable together in a stacked configuration.

17. The floor mat assembly of claim 16 wherein, in the stacked configuration, the textile floor mat and the non-textile floor mat are removably coupled to one another and/or are inhibited from moving relative to one another.

18. The floor mat assembly of claim 17 wherein an underside surface of the textile floor mat member includes a protruding feature that is removably received in a corresponding groove feature defined in an upper surface of the non-textile floor mat.

19. The floor mat assembly of claim 18 wherein removable receipt of the protruding feature in the corresponding groove feature includes a friction fit or snap fit coupling to inhibit removal of the protruding feature from the corresponding groove feature.

20. A two-piece mat assembly, comprising:
a first textile mat member formed of a first textile material; and
a second non-textile mat member formed of a second resilient non-textile member,
wherein the first and second mat members are removably connected to one another and/or are inhibited from moving relative to one another, and further wherein each of the first textile mat member and the second non-textile mat member is independently usable without the other of the first textile mat member and the second non-textile mat member, and wherein the first textile mat member and the second non-textile mat member are usable together in a stacked configuration.
